(19) United States
(12) Patent Application Publication
(10) Pub. No.: US 2026/0111524 A1
(43) Pub. Date: Apr. 23, 2026

(54) TEXT-BASED VALIDATION OF USER INTERFACE TO CONFIRM USER INTENT

(71) Applicant: Google LLC, Mountain View, CA (US)

(72) Inventor: Adam M. Bar-Niv, Los Altos, CA (US)

(21) Appl. No.: 19/117,327

(22) PCT Filed: Sep. 13, 2023
(86) PCT No.: PCT/US2023/032637

§ 371 Date: Mar. 31, 2025

Related U.S. Application Data
(60) Provisional application No. 63/378,716, filed on Oct. 7, 2022.

(51) Int. Cl. G06F 21/32; G06F 3/0488; G06F 21/53; G06F 21/60; G06V 30/10

(52) U.S. Cl. CPC G06F 21/32; G06F 3/0488; G06F 21/53; G06F 21/602; G06V 30/10

(57) ABSTRACT

A computing device engages in text-based validation of a user interface (UI) presented on a display of the computing device, including (i) capturing a screenshot of the display when the UI is presented on the display, (ii) transmitting to a server a validation request providing the captured screenshot, and (Hi) receiving from the server, in response to the validation request, a validation response 2024/076457 based at least on (a) character recognition of text depicted by the screenshot and (b) a determination of whether the character-recognized text corresponds with an associated action. Further, the computing device uses the received validation response as a basis to control whether to allow the computing device to take the associated action in response to user input into the computing device when the UI is presented on the display.

WO

### BACKGROUND

A mobile computing device could be configured to present a user interface (UI) that prompts a user for input to trigger certain action that requires user intent. For example, the computing device could be configured to present a UI that prompts the user to provide biometrics or other input as a trigger and condition for the device to share secure data such as bank information or a digital car key. Upon review of such a UI, the user could therefore respond by providing the requested biometrics or other input, thereby triggering the device to carry out the associated action.

### SUMMARY

Unfortunately, if the operating system or an application on such a device is compromised, a user may be tricked into triggering unintended action, by having the device present a UI that does not represent the action that the user is actually triggering. For instance, malicious software may cause the device to show a prompt for the user to provide biometric authentication and/or to tap a UI button “to accept a $10 coupon into your account” when in fact that user input would actually trigger sharing of the user's digital car key.

One way to help address this issue is to have the device provide a hardware-protected prompt that is very hard for malicious software to fake. For instance, when an application running on the device seeks to present a prompt for user authentication or authorization to take certain action, the application may call an application-programming-interface (API) that causes a Trusted Execution Environment (TEE) or other secure-world environment on the device to securely generate and present an associated UI prompt to which the user could respond to trigger the action. The TEE could be hardware and/or software isolated, to help prevent unauthorized access or modification, which may thereby help prevent faking of the UI prompt.

A practical challenge with implementing this process, however, is that each such UI prompt may include a particular layout of text and images that may be difficult for the TEE to render. For instance, the TEE may have limited font-rendering capabilities or other such restrictions. Further, implementing this process to accommodate an application that may be installed on various devices produced by various manufacturers may require each manufacturer to equip its devices with a TEE or other secure-world environment configured to securely generate and render the desired UI prompts.

Disclosed herein is a technological solution that takes a different approach. In accordance with the disclosure, when a computing device is presenting a UI prompt soliciting user input, the computing device may securely capture a full screenshot showing what is being presented to the user and may send that screenshot to a trusted server for text-based validation. The server may then conduct character recognition as a basis to determine whether the screenshot depicts an expected set of text corresponding with the action that the user input would trigger and may provide the device with an associated validation response that controls whether or not device should take the action in response to the user input, or perhaps whether or not the device should allow the device to provide the user input in response to the UI prompt.

For instance, if the server determines, based at least on the character recognition, that the screenshot contains the expected set of text and/or that the screenshot does not contain unexpected text, then the device may allow itself to take the action in response to the user input. Whereas, if the server determines based at least on the character recognition that the screenshot does not contain the expected set of text and/or that the screenshot contains unexpected text, then the device may prevent itself from taking the action in response to the user input.

Accordingly, in a first respect, disclosed is a method. The method includes a computing device engaging in text-based validation of a presented on a display of the computing device, the text-based validation including (i) capturing a screenshot of the display when the UI is presented on the display, (ii) transmitting to a server a validation request providing the captured screenshot, (iii) receiving from the server, in response to the validation request, a validation response based at least on (a) character recognition of text depicted by the screenshot and (b) a determination of whether the character-recognized text corresponds with an associated action. Further the method includes the computing device using the received validation response as a basis to control whether to allow the computing device to take the associated action in response to user input into the computing device when the UI is presented on the display.

In another respect, disclosed is a computing device. The computing device includes a display, a communication interface, a processing unit, non-transitory data storage, and program instructions stored in the non-transitory data storage and executable by the processing unit to carry out operations. The operations include engaging in text-based validation of a UI presented on the display, the text-based validation including (i) capturing a screenshot of the display when the UI is presented on the display, (ii) transmitting through the communication interface to a server a validation request providing the captured screenshot, (iii) receiving from the server, in response to the validation request, a validation response based at least on (a) character recognition of text depicted by the screenshot and (b) a determination of whether the character-recognized text corresponds with an associated action. Further, the operations include using the received validation response as a basis to control whether to allow the computing device to take the associated action in response to user input into the computing device when the UI is presented on the display.

In yet another respect, disclosed is a non-transitory computer-readable medium having stored thereon instructions executable by a computing device to cause a computing device to carry out operations. The operations include engaging in text-based validation of a UI presented on a display of the computing device, the text-based validation including (i) capturing a screenshot of the display when the UI is presented on the display, (ii) transmitting to a server a validation request providing the captured screenshot, (iii) receiving from the server, in response to the validation request, a validation response based at least on (a) character recognition of text depicted by the screenshot and (b) a determination of whether the character-recognized text corresponds with an associated action. Further, the operations include using the received validation response as a basis to control whether to allow the computing device to take the associated action in response to user input into the computing device when the UI is presented on the display.

In still another respect, disclosed is a method that could be implemented by a server. The method includes the server receiving, from a computing device, a screenshot of a display of the computing device representing a UI presented on the display. Further, the method includes the server conducting character recognition of text depicted by the screenshot and determining whether the character-recognized text corresponds with an associated action. In addition, the method includes the server controlling, based at least on the determining of whether the character-recognized text corresponds with the associated action, whether to allow the computing device to take the associated action in response to user input into the computing device when the UI is presented on the display.

In another respect, disclosed is a server. The server includes a communication interface, a processing unit, non-transitory data storage, and program instructions stored in the non-transitory data storage and executable by the processing unit to carry out operations. The operations include receiving through the communication interface, from a computing device, a screenshot of a display of the computing device representing a UI presented on the display. Further, the operations include conducting character recognition of text depicted by the screenshot and determining whether the character-recognized text corresponds with an associated action. In addition, the operations include controlling, based at least on the determining of whether the character-recognized text corresponds with the associated action, whether to allow the computing device to take the associated action in response to user input into the computing device when the UI is presented on the display.

Further, in still another respect, disclosed is a non-transitory computer-readable medium having stored thereon instructions executable by a processing unit to cause a server to carry out operations. The operations include receiving, from a computing device, a screenshot of a display of the computing device representing a UI presented on the display. Further, the operations include conducting character recognition of text depicted by the screenshot and determining whether the character-recognized text corresponds with an associated action. In addition, the operations include controlling, based at least on the determining of whether the character-recognized text corresponds with the associated action, whether to allow the computing device to take the associated action in response to user input into the computing device when the UI is presented on the display.

In still another respect, disclosed is a system that includes various means for carrying out each of the operations described herein.

These as well as other aspects, advantages, and alternatives will become apparent to those of ordinary skill in the art by reading the following detailed description, with reference where appropriate to the accompanying drawings. Further, it should be understood that the descriptions provided in this summary and below are intended to illustrate the techniques of this disclosure by way of example only and not by way of limitation.

### BRIEF DESCRIPTION OF THE DRAWINGS

FIG. 1 illustrates an example system that uses a digital key to access a secure system.

FIG. 2 is a simplified block diagram of an example computing device.

FIG. 3A illustrates an example key-share graphical user interface (GUI).

FIG. 3B illustrates the example GUI of FIG. 3A with populated fields.

FIG. 3C illustrates the example GUI of FIG. 3B with an overlaid authentication prompt.

FIG. 4A illustrates an example malicious UI.

FIG. 4B illustrates the example UI of FIG. 4A with an overlaid authentication prompt.

FIG. 5 is a simplified block diagram of an example server.

FIG. 6 is a flow chart depicting an example process for controlling action by a computing device.

FIG. 7 is a flow chart depicting another example process.

### DETAILED DESCRIPTION

In line with the discussion above, the disclosed principles could help to confirm that, when a user provides input that would trigger a particular action, the user actually intends the user's input to trigger that particular action. The following description will primarily address example implementation in the context of a computing device sharing a digital key. It should be understood, however, that the disclosed principles could extend to apply in other contexts as well, such as with respect to sharing of other information and/or taking of other action, among other possibilities.

Example methods, devices, and systems are described herein. It should be understood, however, that any disclosed example is not necessarily to be construed as preferred or advantageous over other example unless stated as such. Further, it should be understood that variations from the specific arrangements and processes disclosed are possible. For instance, various disclosed entities, components, connections, operations, and other elements could be added, omitted, distributed, replicated, re-located, re-ordered, combined, or changed in other ways. In addition, it should be understood that various disclosed technical operations could be implemented at least in part by a processing unit programmed to carry out the operations or to cause one or more other entities to carry out the operations.

An example computing device could be configured with digital key technology to facilitate accessing a secure system. Without limitation, a representative computing device could be a smart phone, a tablet computer, a laptop computer, a gaming device, a smart watch or other wearable device, a medical device, or an embedded or implanted device, among other possibilities. Further, without limitation, a representative secure system could be a vehicle (e.g., a car, truck, boat, plane, etc.), a house, hotel room, or other dwelling, a safe, a security system, and/or another physical system that can be locked and require a key to access. The act of accessing the secure system could involve gaining entry into the secure system, such as unlocking a car or unlocking the front door of a house, etc. Alternatively or additionally, the act of accessing the secure system could involve changing a state of the secure system, such as turning on a car engine, disarming a security system, etc.

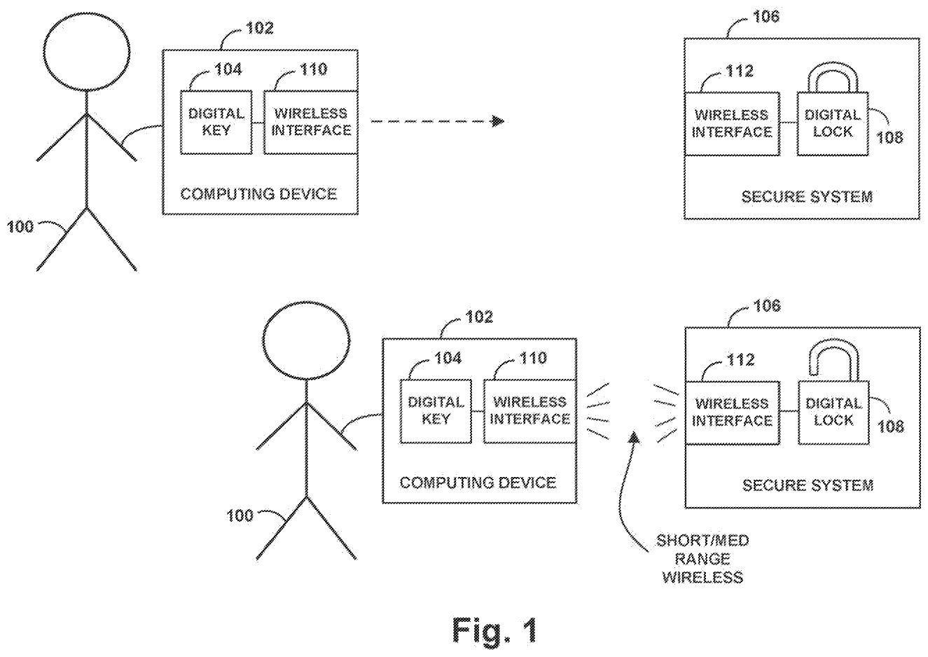

FIG. 1 illustrates an example use of a digital key to access a secure system. In particular, the figure shows a user 100 carrying a computing device 102 that includes a digital key 104 and using the digital key 104 to gain access to a secure system 106 that includes a digitally controlled lock (digital lock) 108.

As illustrated, the example computing device 102 and secure system 106 are equipped with respective wireless communication interfaces supporting direct wireless communication with each other. Namely, the computing device 102 includes a wireless communication interface 110, and the secure system 106 includes a corresponding wireless communication interface 112. These wireless communication interfaces could be Near Field Communication (NFC) interfaces, supporting peer-to-peer communication with each other when within very close range of each other (e.g., on the order of up to 4 centimeters), in order to help avoid unintended communication. Alternatively, the interfaces could take other forms, such as ultra wide band (UWB) or Bluetooth interfaces for instance.

As shown in FIG. 1, the digital lock 108 of the secure system 106 may be in a locked state by default, preventing unauthorized access to the secure system 106. When the user 100 brings the computing device 102 within close enough range of the secure system 106, however, the digital key 104 in the computing device 102 may wirelessly communicate with the digitally controlled lock 108 in the secure system 106, to unlock the digital lock 108 and provide the user 100 with access to the secure system 106. With NFC, for instance, when the user 100 brings the wireless communication interface 110 of the computing device 102 close enough to the wireless communication interface 112 of the secure system, inductive coupling between the two modules may trigger signaling between the device 102 and the secure system 106, to authenticate the digital key 104 and to unlock the digital lock 108.

In some examples, device 102 may include a display that displays a user interface that includes information, such as about the authentication or other action. The information included in the interface may be associated with an action to be performed by device 102 or may be associated with a different action. Device 102 may engage in in text-based validation of the user interface to validate where the information included in the interface is indicative or otherwise associated with the underlying action that is to be performed by device 102 (e.g., in response to receiving a user input initiating the action). In engaging in the text-based validation of the user interface, device 102 may capture a screenshot of the display when the user interface is presented on the display. Device 102 may only capture the screenshot if explicit consent to do so is provided by a user of device 102. For example, device 102 may display a prompt notifying a user of device 102 of the screenshot capturing capabilities of device 102 and, in some examples, the purpose for capturing such screenshots. A user of device 102 may provide permission to device 102 that permits device 102 to automatically capture a screenshot (e.g., when an associated action may provide sensitive information to another device or service). Alternatively, the user of device 102 may reject such permissions and prevent device 102 from automatically capturing such screenshots. Absent such explicit consent, device 102 will not capture screenshots for validating actions performed by device 102.

Device 102 may also transmit, to a server, a validation request providing the captured screenshot. Responsive to the transmitting the validation request, device 102 may receive, from the server, a validation response based at least in part on one or more of character recognition of text depicted by the screenshot and a determination of whether the character-recognized text corresponds with an associated action. Device 102 may use the received validation response as a basis to control whether to allow the computing device to take the associated action in response to user input into the computing device when the user interface is presented on the display.

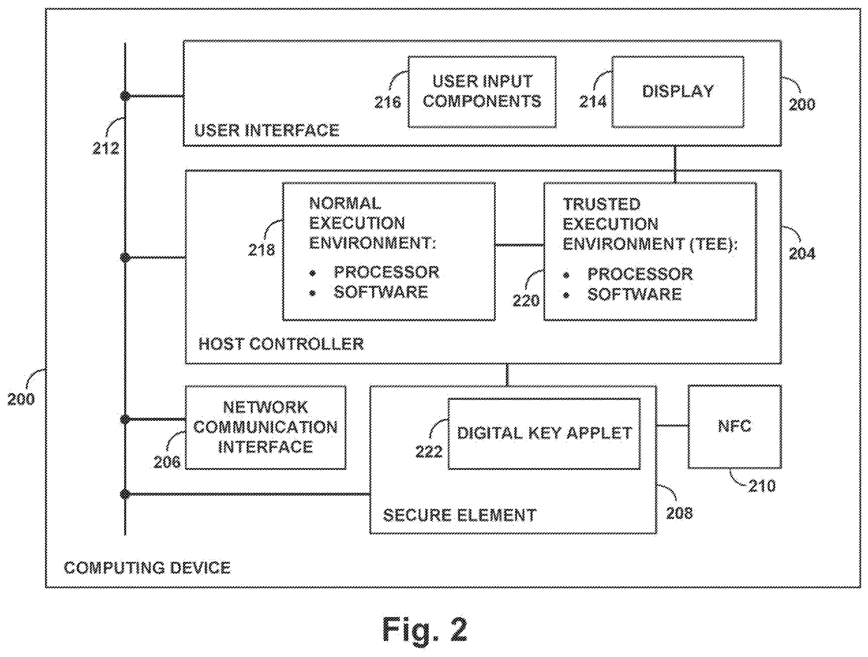

FIG. 2 is a simplified block diagram of a representative computing device 200, showing some of the components that could be included in the device to facilitate operations like those described herein. As shown, the example device 200 includes a user interface 202, a host controller 204, a network communication interface 206, a secure element 208, and an NFC interface 210. These components could be interconnected, integrated, and/or communicatively linked together in various ways. For instance, the figure depicts the user interface 202, host controller 204, network communication interface 206, and secure element 208 being interconnected by a system bus 212. Further, the figure depicts direct hardware connections (possibly supporting Secure Channel Protocol (SCP) communication) between the secure element 208 and the NFC interface 210, between the secure element 208 and the host controller 204, and between the host controller 204 and the user interface 202. Other arrangements are also possible. Without limitation, for instance, the device could include other direct connections between its components.

As shown, the user interface 202 includes a display 214 and user-input components 216. The display 214 could be configured to present visual content such as images and text, as a GUI for viewing by and interaction with a user of the device 200. The user-input components 216 could then include various components that enable the user to provide input to the device and enable the device to receive that user input. Without limitation, these input components 216 could include a touch-screen interface enabling user input by touching at defined coordinates on a presented GUI, a microphone enabling speech input, and one or more buttons (e.g., mechanical, capacitive-sensing, and/or other buttons) enabling user input by button pressing. Further, the input components 216 may include one or more biometric sensors configured to receive biometric data such as a fingerprint scan, iris, or face scan, to facilitate user authentication.

The host controller 204 could operate to carry out or cause the device 200 to carry out various device operations described herein. To facilitate this, the host controller 204 could include at least one processor (e.g., one or more general purpose processors such as microprocessors and/or one or more special purpose processors such as application specific integrated circuits), non-transitory data storage (e.g., one or more volatile and/or non-volatile storage components, such as magnetic, optical, and/or flash storage), and program instructions stored in the non-transitory data storage and executable by the processor to carry out or cause the device to carry out the various operations.

As shown, the host controller 204 could be segregated into two separate execution environments: a normal execution environment 218 and a trusted execution environment (TEE) 220 as described above. These execution environments may occupy separate areas of a main processor of the device, each effectively having its own processor resources and its own software. The normal execution environment 218 may include a main operating system of the device as well as various applications running on that operating system, and the TEE 220 may be an isolated and protected environment, enabling secure execution of code and secure interaction with certain hardware components. In an example arrangement, TEE 220 may have the above-noted direct connections with the user interface 202 and with the secure element 208. Further, as shown, the normal execution environment 218 may have an interface with the TEE 220, to facilitate interacting with the TEE 220, such as to request service of the TEE 220 and to receive output from the TEE 220.

The network communication interface 206 could operate to facilitate communication between the device 200 and remote network entities such as servers. As such, the communication interface 206 may include a wireless communication interface, with a transceiver and antenna structure, to facilitate wireless communication according one or more cellular or local air interface protocols, and/or the communication interface may include a wired communication interface such as a wired Ethernet port, to facilitate wired network communication, among other possibilities.

The secure element 208 could be a separate processing subsystem of the device 200, protected from unauthorized access and configured to run a limited set of applications and to store confidential and cryptographic data. In the example device 200, the secure element 208 could act as a secure execution environment for a digital key applet 222, which could host one or more digital keys and implement transactions between the device and one or more secure systems. The secure element 208 could be configured as a system on a chip (SoC) with its own processor, memory, and persistent storage, and with a locked-down operating system that may require privileged access authenticated by cryptographic keys to manage.

As shown and as noted above, the secure element 208 could have a direct connection with the NFC interface 210. The NFC interface 210 could facilitate short-range wireless communication with a corresponding NFC module of a secure system. A representative NFC interface, for instance, could include an NFC controller and a loop antenna, to facilitate inductive coupling with a corresponding NFC module of the secure system. The NFC interface 210 could take other forms as well. The direct connection between the secure element 208 and the NFC interface 210 may enable the digital key applet 222 to engage in wireless communication with a secure system, without having the host controller 204 see those communications.

To facilitate gaining access to an external secure system, the confidential and cryptographic data stored in the secure element 208 of this example device 200 could be used as a digital key through interaction with a corresponding digital lock in the secure system. This process could take various forms. Without limitation, for instance, the digital key applet 222 and the digital lock of the secure system could use a challenge-response handshake, where the digital lock generates and sends to the digital key applet 222 a random value, the digital key applet 222 uses a private key to sign the random value and sends the resulting digital signature back to the digital lock, and the digital lock then uses a public key to verify the digital signature as a condition for granting access.

Using NFC for instance, the digital key applet 222 of the example device 200 could engage in this or another exchange with digital lock application logic of the secure system when the wireless communication interface 206 of the device 200 is brought in close enough proximity to the wireless communication interface of the secure system. For instance, the wireless communication interface 206 of the device 200 and/or the wireless communication interface of the secure system could regularly monitor for each other's presence and, upon inductively coupling with each other, could then signal to their associated application logic to trigger the process. The digital key applet 222 of the device 200 could then wirelessly communicate with the digital lock of the secure system in an effort to establish digital key authenticity and gain access to the secure system.

Among other operations, the example device 200 may support digital-key sharing. To facilitate this, a wallet application or other application that runs in the normal execution environment 218 of the device may provide a key-share option that enables the device user to request sharing of a digital key with a friend and that invokes sharing of the digital key in response to the user request.

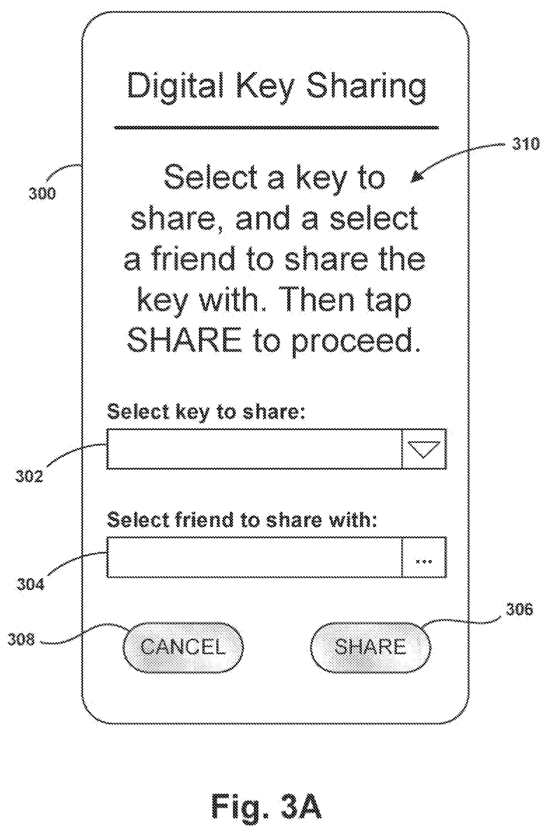

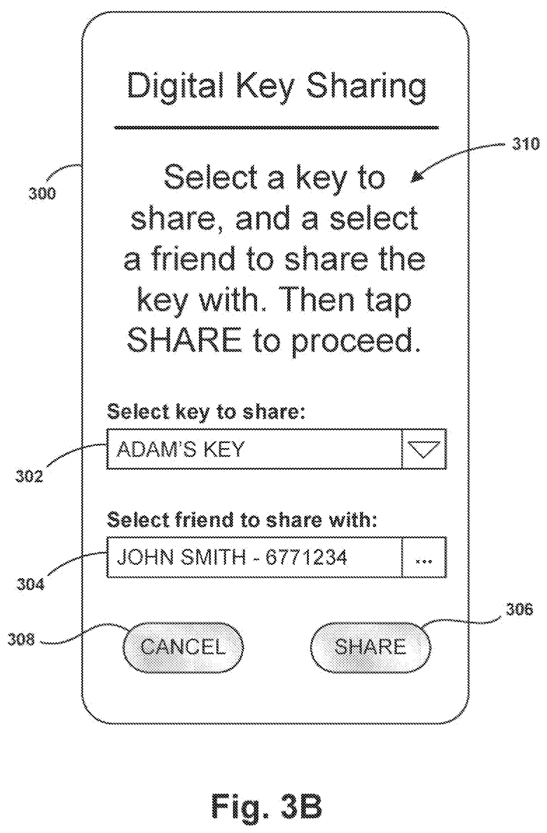

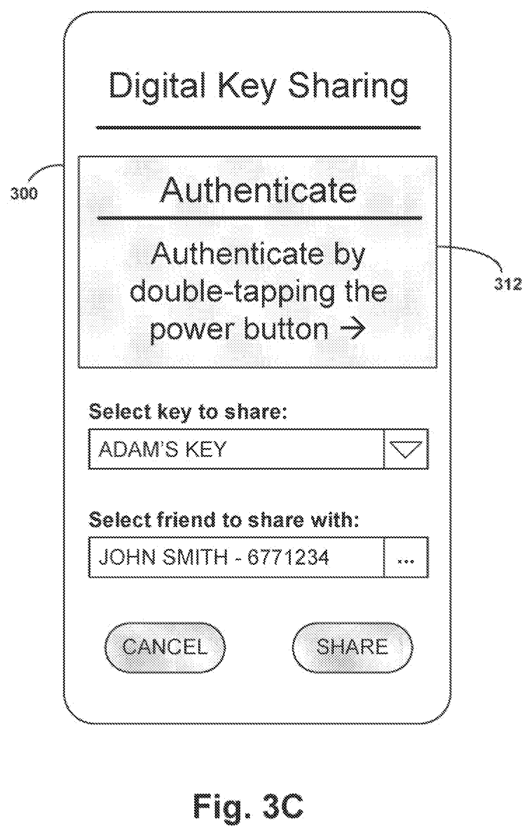

In an example key-sharing process, when the user navigates to the key-share option in the wallet application, the application may cause the device 200 to present on the display 214 a key-share GUI. FIG. 3A illustrates an example of this GUI 300. This example key-share GUI 300 includes a key-selection object (e.g., a drop-down box) 302 with which the user can interact in order to identify the digital key that the user would like to share, and a target-selection object (e.g., a button and associated text field) 304 with which the user can interact, in order to specify a target user to receive the shared key. Further, the GUI 300 includes labeled “SHARE” and “CANCEL” buttons 306, 308 that the user could select in order to either proceed with the sharing or cancel the sharing. In addition, the GUI 300 includes text 310 instructing the user how to proceed.

FIG. 3B illustrates what this example key-share GUI 300 could look like in an example implementation once the user identifies a digital key to share and specifies a target user to receive the identified key. Namely, the GUI 300 shows the digital key as being “Adam's Key” and the target user as being John Smith with a user identifier of 6741234. For instance, if the digital key applet 222 stores one or more digital keys including at least “Adam's Key”, the user may have interacted with the key-selection object 302 to select “Adam's Key” as the key to be shared. Further, the user may have interacted with the target-selection object 304 to select from a contacts application on the device 200 a friend named John Smith to receive the shared key, which may have populated the key-share GUI 300 with the account associated user identifier. The user may then select the SHARE button 306 to proceed with the key-sharing process.

Once the user selects the SHARE button 306, the wallet application may then signal to the TEE 220 to trigger a secure process of authenticating the user, as a condition precedent to allowing the key-sharing process to proceed. For instance, the wallet application may call a user-authentication API associated with the TEE 220, and the TEE 220 may then engage in a process to authenticate the user. When calling this authentication API, the application may provide as arguments information about the requested key sharing, such as the identity of the key to be shared and the identity of the target user to receive the shared key.

In an example authentication process, the TEE 220 may overlay on the display (e.g., superimposed over the key-share GUI 224) a user-authentication prompt 312 that asks the user to authenticate using a fingerprint, iris, or face scan, credential entry, or another mechanism. FIG. 3C illustrates how this could look in an example implementation, where the overlaid prompt 312 asks the user to authenticate by double-tapping a power button of the device and then allowing the device to perform a face scan. This authentication prompt 312 may have predefined format, size, content, display position, and/or other properties. As shown, in the example, the authentication prompt 312 may overlay just part of the underlying key-share GUI 300, leaving exposed some information about the key-sharing, so that the user can see what will happen upon user authentication.

Once the user successfully authenticates with this example process, the TEE 220 may then either respond to the wallet application to trigger the key-sharing to proceed or signal directly to the secure element 208 to trigger the key sharing. In an example implementation where the TEE 220 responds to the wallet application, the TEE 220 may provide the wallet application with an encrypted attestation that includes the information that the wallet application provided about the requested key sharing, the wallet application may convey that attestation to the secure element 208, and the secure element 208 may decrypt the attestation and then proceed with the requested key sharing. Alternatively, in an example implementation where the TEE 220 signals directly to the secure element 208, the TEE 220 may send such an encrypted attestation directly to the secure element 208, and the secure element 208 may likewise decrypt the attestation and then proceed with the requested key sharing.

The process of the secure element 208 carrying out the key sharing once so approved could take various forms. Without limitation, for instance, the secure element 208 may encrypt the specified key and transmit the encrypted key to a digital key server along with the identity of the target user, and the digital key server may then decrypt the key, re-encrypt the key in a manner that can be decrypted by the target user's device, and send the encrypted key to the target user's device, and the target user's device may then decrypt and securely store the key for use by the target user.

In line with the discussion above, an issue that could arise with this digital-key sharing process is that malicious code may seek to trick a user into sharing a key by making the user think that the user is approving a different device action. For instance, malicious code running in the normal execution environment 218 of the device may programmatically open the key-share option of the wallet application, identify a digital key (e.g., “Adam's key”) to share, and set the target user to be a rogue actor who would receive the shared key. Further, the malicious code may superimpose over the key-share GUI 300 a malicious UI prompt that purports to have the user approve receipt of a coupon when in fact the user would unknowingly be invoking sharing of a digital key.

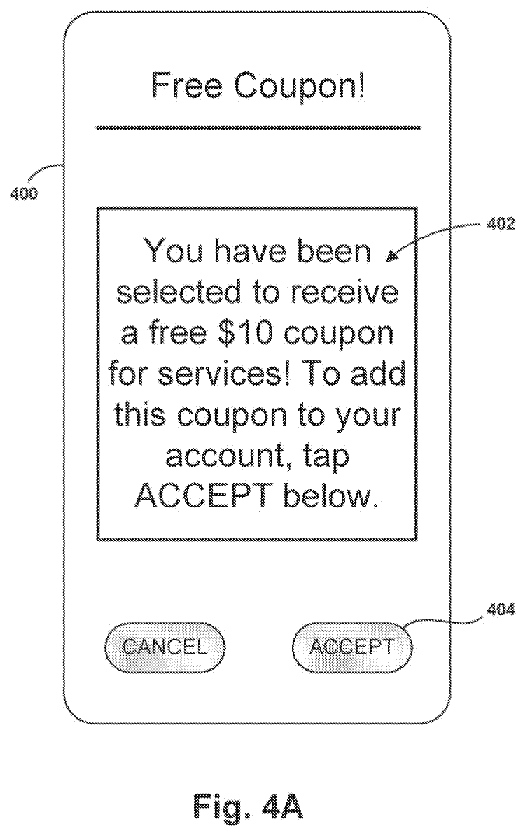

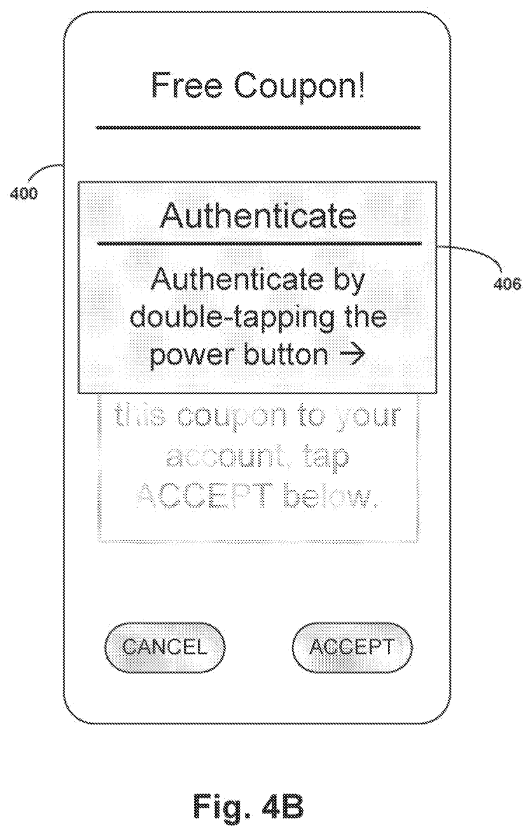

FIG. 4A shows how such a malicious UI prompt 400 might look in an example scenario. As shown, the example malicious UI prompt 400 overlays the full display area that would be taken up by the key-share GUI 300. Further, the malicious UI prompt 400 may be configured such that, (i) in place of the actionable key-selection object 302 and target-selection object 304, the malicious UI prompt 400 includes text 402 that seeks to convince the user to accept a valuable coupon and (ii) overlaid on the SHARE button 306 of the key-share GUI 300, but still maintaining the actionable nature of the SHARE button 306, the malicious UI prompt 400 presents an “ACCEPT” image 404. With this arrangement, the user may consider the presented UI prompt 400 to be a useful pop-up offer, and the user may click on the ACCEPT image 404, thus unwittingly triggering the underlying key-sharing process. In turn, as discussed above, the wallet application may call the TEE API, and the TEE may superimpose over the UI prompt 400 an authentication prompt 406 like that discussed above, as shown next in FIG. 4B. Then faced with this authentication prompt 406, to process what the user thinks is acceptance of a valuable coupon, the user may engage in the requested authentication. However, what would really happen at that point is that the device would then share the user's key with the rogue actor.

As discussed above, to help address this or other such situations, the present disclosure provides for using text-based validation to help confirm that the user really intends to have the device take the action that the device would take in response to the user input into the device, and to control whether or not to allow the device to do so.

In an example implementation, when the device is presenting a UI and the device would receive user input and respond by taking particular action, the device could capture a screenshot of what is presented on the display and could send that screenshot to a server in order to trigger text-based validation of the UI in relation to that action, and the device could then use the result of that text-based validation process as a basis to control whether or not to allow that action to be taken.

More particularly, when the device is presenting a UI on its display, the device could engage in a text-based validation process of the UI, including (i) capturing a screenshot of the display, (ii) transmitting to a server a validation request providing the captured screenshot, and (iii) receiving from the server, in response to the validation request, a validation response based at least on (a) character recognition of text depicted by the screenshot and (b) a determination of whether the character-recognized text corresponds with an associated action. The device could then use this validation response as a basis to control whether to allow the device to take the associated action in response to user input received when the UI is presented on the display.

In practice, the device may engage in this process when the UI is presented, i.e., when the display is showing the UI, and before the device receives the user input that would trigger the associated action. The device could then use the result of the text-based validation as a basis to control whether to even proceed with receiving the user input that would trigger the associated action, or the device could use the result of the text-based validation as a basis to control whether to then take the associated action once the device receives the user input. Alternatively, the device may engage in this process when the UI is presented and once the device receives the user input that would trigger the associated action. The device could then use the result of the text-based validation as a basis to control whether to take the associated action in response to the received user input. Other scenarios could be possible as well.

In an example implementation, the screenshot that the device captures and sends to the server to facilitate text-based validation of the UI could be a full screenshot, capturing the entirety of the viewable display area (e.g., from top to bottom and side to side), though it may exclude one or more system regions such as a status bar or the like. An object in capturing the full display area could be to enable the server to perform text-based validation as to any and all text that may be reasonably visible to the device user at the time the user would provide the user input that would trigger the associated action. In an alternative implementation, however, the screenshot may capture less than the full display area.

Further, the server to which the device sends the validation request could be a server that is preconfigured to handle text-based validation of the type of UI at issue. For instance, with the digital key sharing example, the server could be a server that is preconfigured with specifications of what text the UI would be expected to present when legitimately prompting the device user to approve digital key sharing, and perhaps various expected properties of that expected text, such as expected relative size and/or and position (e.g., display coordinates) of the text in relation to the display viewport. Whereas, in another example that may address a different type of UI or vary in other ways, the server to which the device sends the validation request may be a different server that is preconfigured with other associated specifications of the expected text.

With the example key-sharing scenarios discussed above, this process could play out in various ways.

As one example, when the wallet application outputs for presentation on the display 214 the key-share GUI 300 as shown in FIG. 3A, optionally once that GUI 300 has been populated with information indicating the key to be shared and indicating the target user to receive the shared key as shown in FIG. 3B, the application may then call TEE API as discussed above. Before the TEE API then presents the authentication prompt 312 to ask for biometric authentication, however, the TEE could respond to the call from the wallet application by (i) capturing a screenshot of what is currently shown on the display, (ii) cryptographically signing a data package that contains the captured screenshot image, the associated key-sharing data such as the key identity and target-user identity, and other information such as a timestamp and device identifier, and (iii) transmitting that cryptographically signed data package in response to the wallet application. The wallet application could then transmit to a digital key server a validation request carrying that cryptographically signed data package.

When the server receives this signed data package, the server could then use a public key of the device to decrypt the package and to uncover the contents of the package. The server may then engage in text-based validation of the UI to determine whether the UI legitimately prompts for user input to engage in the indicated digital key sharing. For instance, the server could programmatically conduct optical character recognition on the screenshot image to identify text that is depicted by the screenshot and thus text that is shown on the display of the device. (This optical character recognition could involve converting text depicted by the screenshot image into machine-coded text, and may take various forms including but not limited to pattern matching and/or feature extraction.) The server could then determine whether that character-recognized text corresponds with the action that would be taken if the user proceeds, namely in this example, with sharing of the indicated digital key.

At issue in this process could be whether the character-recognized text includes text that would be expected to correspond with the action that would be taken. Further, at issue could be whether the only text in the screenshot is the text that the server expects to be present in a legitimate prompt for the key sharing, i.e., that there is not additional extraneous text that may mislead the user. Still further, at issue may be whether the character-recognized in the screenshot has one or more properties that the server expects the text to have in such a legitimate prompt, such as that the text has an expected relative or absolute size, an expected relatively or absolute position (e.g., display coordinates), an expected color, an expected font, and/or the like.

To perform this analysis in the example scenario, the digital key server may be preconfigured with a template that specifies what text would be present on the display, and possibly various expected properties of that text for a legitimate key-sharing prompt. For instance, the template may specify the text that key-share GUI 300 would include. This may include various static text as shown in FIG. 3A. In addition, the template may include placeholders for dynamic text such as the identity of the key to be shared and/or the identity of the target user. As to the identity of the key to be shared, the digital key server may have access to data that indicates keys stored on the device 200, and as to the identity of the target user, the digital key serve may have access to data that indicates pre-authorized friends of the device user. The digital key server may thus use this or other such information in the course of determining whether the UI is legitimate and thus what validation response to provide.

In this example, if the digital key server determines that character-recognized text in the screenshot meets the specifications of text in line with key-share GUI 300, and optionally that the screenshot does not include any extraneous text that might mislead the user, then the digital key server may conclude that the UI is valid and may responsively return to the wallet application an affirmative validation response. In practice, the digital key server may cryptographically sign this validation response. Upon receipt of the validation response, the wallet application may then forward the response to the TEE 220, and the TEE 220 may decrypt the response to determine that it is affirmative. In response to this affirmative text-based validation of the UI, the TEE 220 may then proceed with the process as discussed above. For instance, the TEE 220 may then present the authentication prompt 312, receive user biometric authentication, and proceed to signal back to the wallet application or to the secure element 208 to invoke the key sharing.

On the other hand, if the digital key server determines that the character-recognized text in the screenshot does not meet the specifications of text in line with the key-share GUI 300 and/or that it includes extraneous text, then the digital key server may instead provide a negative validation response.

For instance, if the UI shown by the display was the malicious UI prompt 400, then the character-recognized text that the digital key server finds in the screenshot would not include the expected text of the key-share GUI 300 and/or the character-recognized text that the digital key server finds in the screenshot would include other text, namely, the text of the malicious UI prompt 400. Based at least on this text analysis, the digital key server may determine that the UI presented by the device display does not legitimately correspond with the sharing of the digital key indicated by the validation request. Therefore, the digital key server may responsively return to the wallet application a negative validation response, likewise cryptographically signed.

Upon receipt of this validation response, the wallet application may likewise forward the response to the TEE 220. However, in this instance, upon decrypting the response, the TEE 220 would see that the validation response is negative. Therefore, rather than proceeding with the process as discussed above including presenting the authentication prompt 312 and so forth, the TEE 220 may return an error or negative authentication result to the wallet application, to end the process, thus avoiding the illegitimate sharing of the digital key.

In another example of the present process, the TEE 220 could invoke the text-based validation process once the TEE 220 has output for presentation the authentication prompt 312 as an overlay on the key-share GUI 300 as shown in FIG. 3C and possibly once the user has double-tapped the power button and successfully provided biometric authentication. Likewise here, the TEE 220 could capture a screenshot of the display and could send to the wallet application a cryptographically signed data package carrying that screenshot and the other data as noted above, and the wallet application could send that cryptographically signed data package in a validation request to the digital key server. Further, the digital key server could then likewise engage in character recognition to recognize text in the screenshot image and could determine based on the character-recognized text whether the UI presented on the display is legitimate and could generate and return to the wallet application a cryptographically signed validation response based on that determination. However, in this example, the template that the digital key server uses may include the authentication prompt text as well.

In this example, when the wallet application receives the cryptographically signed validation response from the digital key server, the wallet application could then provide the validation response to the TEE 220 or the secure element 208 as a way to control whether the key sharing process will occur.

For instance, the wallet application could provide the validation response to the TEE 220, and the TEE 220 could decrypt the validation response to determine whether it is affirmative or negative and could operate accordingly. If the TEE 220 determines that the validation response is affirmative, then the TEE 220 may signal to the secure element 208 to invoke the key sharing. Whereas, if the TEE 220 determines that the validation response is negative, then the TEE 220 may return an error result to the wallet application, to end the process, thus avoiding the illegitimate sharing of the digital key.

Alternatively, the wallet application could provide the validation response to the secure element 208, and the secure element 208 could decrypt the validation response to determine whether it is affirmative or negative and could operate accordingly. If the secure element 208 determines that the validation response is affirmative, then the secure element 208 may proceed with the indicated key sharing. Whereas, if the secure element 208 determines that the validation response is negative, then the secure element 208 may return an error result to the wallet application, to end the process, thus avoiding the illegitimate sharing of the digital key.

In these or other implementations, in order to help ensure that the screenshot truly represents what is shown to the user at the time the user would provide input to trigger action by the device, the device could freeze the display during the course of this process.

For instance, once the TEE 220 receives signaling from the wallet application that would trigger the TEE 220 to capture a screenshot before the TEE 220 has presented the authentication prompt, the TEE 220 may engage in control signaling to the display 214 to prevent the display from changing what the display is currently showing, and the TEE 220 may then capture the screenshot and proceed as noted above to facilitate in text-based validation of the presented UI, after which the TEE 220 may then engage in further signaling to unfreeze the display 214. Alternatively, if and when the TEE 220 then presents the authentication prompt 312, the TEE 220 could then likewise freeze the display until the device receives user input in the form of a biometrics scan in response to that authentication prompt 312.

Without limitation to digital key sharing, the presently disclosed process may optimally facilitate providing an open API through which application developers could help to ensure the validity of UIs in relation to actions that their applications would take or trigger. For instance, a provider of the device operating system may offer a system that the developer of an application could access and use to define (i) expected text, and possibly associated properties as discussed above, that would be present on a legitimate UI of the application that would solicit user input to trigger a device action and (ii) the device action that would be triggered by the user input when that legitimate UI is presented. Given this information from the developer, the operating system provider may then provision a server to be able to engage in text-based validation as described above and to provide a validation response to the device, in order to determine whether what is shown on the display of a device when the application would respond to user input by carrying out a particular action is actually a legitimate UI associated with that action, and to control operation accordingly.

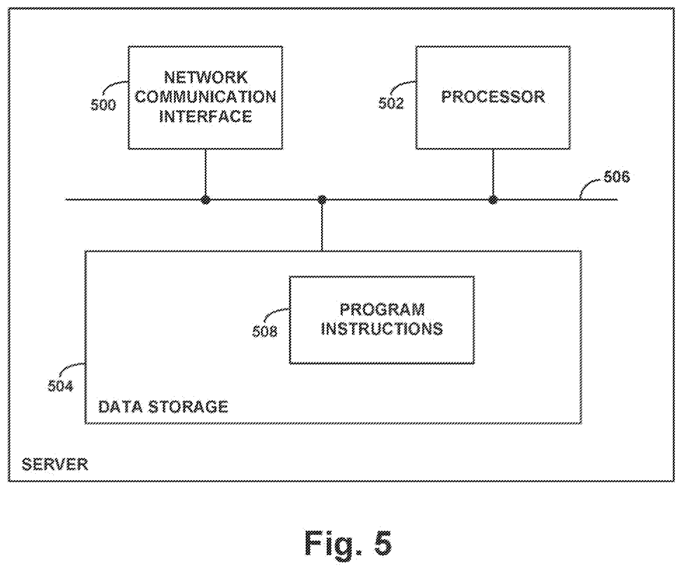

FIG. 5 is a simplified block diagram of an example server that could operate in these or other example implementations. As shown, the example server includes a network communication interface 500, a processor 502, and non-transitory data storage 504, all of which may be communicatively linked together by a system bus or other connection mechanism 506.

The network communication interface 500 could comprise any wired or wireless communication module, such as an Ethernet module, that facilitates network communication with other entities, such as with device 200. The processor 502 could comprise one or more general purpose processors (e.g., microprocessors) and/or one or more special purpose processors (e.g., application specific integrated circuits). The non-transitory data storage 504 could then comprise one or more volatile and/or non-volatile storage components, such as optical, magnetic, flash, ROM, RAM or other storage. As shown, the non-transitory data storage 504 could hold program instructions 508. These program instructions 508 could be executable by the processor 502 to carry out various server operations. Thus, the server could be configured to carry out various such operations by being programmed with instructions executable by the processor 502 to carry out those operations, among other possibilities.

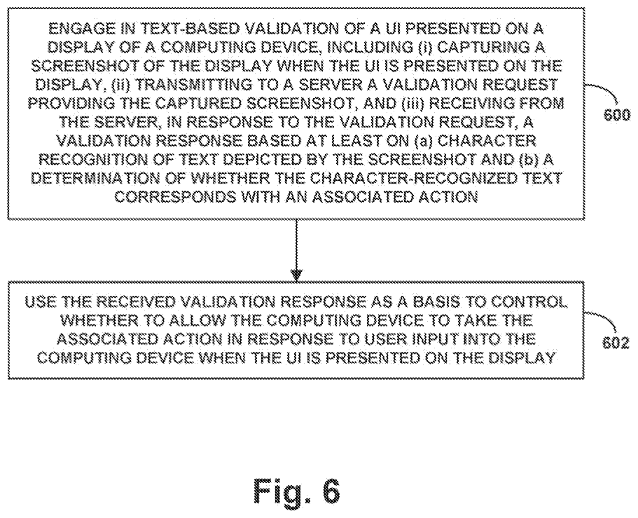

FIG. 6 is a flow chart depicting an example process for controlling action by a computing deviceⁱ. As shown in FIG. 6, at block 600, the process includes the computing device engaging in text-based validation of a UI presented on a display of the computing device, with the engaging in the text-based validation of the UI including (i) capturing a screenshot of the display when the UI is presented on the display, (ii) transmitting to a server a validation request providing the captured screenshot, and (iii) receiving from the server, in response to the validation request, a validation response based at least on (a) character recognition of text depicted by the screenshot and (b) a determination of whether the character-recognized text corresponds with an associated action. At block 602, the process then involves the computing device using the received validation response as a basis to control whether to allow the computing device to take the associated action in response to user input into the computing device when the UI is presented on the display.

In line with the discussion above, the act of transmitting to the server the validation request providing the captured screenshot could involve encrypting the captured screenshot, among possibly other information, and transmitting the encrypted captured screenshot to the server.

Further, as discussed above, the user input into the computing device when the UI is presented on the display could include user biometrics data. Still further, the user input into the computing device when the UI is presented on the display could include at least one of (i) entry through a touch-screen interface of the display, (ii) entry through pressing of a button on the computing device, and (iii) biometric input, such as sensing by a biometric sensor.

In addition, as discussed above, the screenshot could be a full screenshot of the display. Further, the validation response could be based on a determination that the only text depicted by the screenshot is an expected set of text corresponding with the associated action. Still further, the validation response could be based further on at least size or display coordinates of the expected set of text. Yet further, the expected set of text could comprise static text and/or dynamic text.

As additionally discussed above, the act of capturing the screenshot could be controlled by a secure-world subsystem of the computing device, such as by a TEE for instance.

Further, as discussed above, the act of using the received validation response as a basis to control whether to allow the computing device to take the associated action in response to user input into the computing device when the UI is presented on the display could be based on whether the validation response is affirmative.

In addition, the act of using the received validation response as a basis to control whether to allow the computing device to take the associated action in response to user input into the computing device when the UI is presented on the display could involve using the received validation response to control whether or not to allow receipt of the user input when the UI is presented on the display, such as whether to continue with a process that would trigger and allow that input.

Alternatively, the act of using the received validation response as a basis to control whether to allow the computing device to take the associated action in response to user input into the computing device when the UI is presented on the display could involve, after receiving the user input, using the received validation response as a basis to control whether or not to then take the associated action. Thus, the process could involve detecting receipt of the user input into the computing device, and then using the validation response as a basis to respond to that user input by taking the associated action.

Yet further, as discussed above, the associated action at issue could include sharing of secure data, such as sharing of a digital key, financial information, or other data.

In line with the discussion above, the present disclosure also contemplates a computing device having a display, a communication interface, a processing unit, non-transitory data storage, and program instructions stored in the non-transitory data storage and executable by the processing unit to cause the computing device to carry out operations of such a process. For instance, the operations could include engaging in text-based validation of a UI presented on the display, with the engaging in the text-based validation of the UI including (i) capturing a screenshot of the display when the UI is presented on the display, (ii) transmitting, through the communication interface, to a server a validation request providing the captured screenshot, and (iii) receiving from the server, in response to the validation request, a validation response based at least on (a) character recognition of text depicted by the screenshot and (b) a determination of whether the character-recognized text corresponds with an associated action. In addition, the operations could include using the received validation response as a basis to control whether to allow the computing device to take the associated action in response to user input into the computing device when the UI is presented on the display.

Further, the present disclosure also contemplates at least one non-transitory computer-readable medium (e.g., optical, magnetic, flash, ROM, RAM or other storage) encoded with, embodying, or otherwise storing program instructions executable by at least one processing unit (e.g., at least one microprocessor) to carry out various operations as described herein.

Various other features described herein could be applied in these contexts as well, and vice versa.

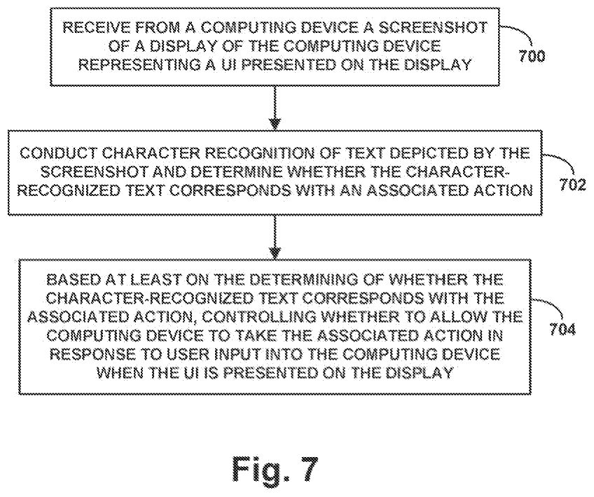

FIG. 7 is next a flow chart illustrating a process that could be carried out from the perspective of a server or other entity. As shown in FIG. 7, at block 700, the process includes the receiving from a computing device a screenshot of a display of the computing device representing a UI presented on the display. Further, at block 702, the process includes conducting character recognition of text depicted by the screenshot and determining whether the character-recognized text corresponds with an associated action. In addition, at block 704, the process includes controlling, based at least on the determining of whether the character-recognized text corresponds with the associated action, whether to allow the computing device to take the associated action in response to user input into the computing device when the UI is presented on the display.

Here, the act of controlling, based at least on the determining of whether the character-recognized text corresponds with the associated action, whether to allow the computing device to take the associated action in response to user input into the computing device when the UI is presented on the display could involve the server sending to the computing device a signal to which the computing device is configured to respond accordingly. For instance, if the server determines that the character-recognized text corresponds with the associated action, then the server may send to the computing device a signal to which the computing device would respond by allowing itself to take the associated action in response to the user input when the Ul is presented on the display. Whereas, if the server determines that the character-recognized text does not correspond with the associated action, then the server may send to the computing device a signal to which the computing device would respond by not allowing itself to take the associated action in response to the user input when the UI is presented on the display.

In addition, the present disclosure also contemplates a server being configured to carry out this process, and the present disclosure further contemplates a non-transitory computer-readable medium storing program instructions executable by at least one processing unit to carry out similar operations.

Various other features described herein could be applied in these contexts as well, and vice versa.

The present disclosure also contemplates a process carried out by a computing system that includes a computing device such as that noted above for instance. This computing system could include at least one processing unit, non-transitory data storage, and program instructions stored in the non-transitory data storage and executable by the at least one processing unit to carry out operations such as (i) engaging in optical character recognition of text depicted by a screenshot of the device display that was captured when the display was presenting a UI, (ii) determining whether the character-recognized text corresponding with an associated action, and (iii) based on the determining, controlling whether to allow the device to carry out the associated action in response to user input into the computing device when the UI is presented on the display. Such a process and computing system could be implemented at the computing device itself and/or at another entity.

Example 1. A method comprising: engaging, by the computing device, in text-based validation of a user interface (UI) presented on a display of the computing device, wherein engaging in the text-based validation of the UI includes (i) capturing a screenshot of the display when the UI is presented on the display, (ii) transmitting to a server a validation request providing the captured screenshot, and (iii) receiving from the server, in response to the validation request, a validation response based at least on (a) character recognition of text depicted by the screenshot and (b) a determination of whether the character-recognized text corresponds with an associated action; and using, by the computing device, the received validation response as a basis to control whether to allow the computing device to take the associated action in response to user input into the computing device when the UI is presented on the display.

Example 2. The method of example 1, wherein transmitting to the server the validation request providing the captured screenshot comprises encrypting the captured screenshot and transmitting the encrypted captured screenshot to the server.

Example 3. The method of any of examples 1 or 2, wherein the user input into the computing device when the UI is presented on the display comprises user biometrics data.

Example 4. The method of any of examples 1-3, wherein the user input into the computing device when the UI is presented on the display comprises at least one of (i) entry through a touch-screen interface of the display, (ii) pressing of a button on the computing device, or (iii) biometric input.

Example 5. The method of any of examples 1-4, wherein the screenshot is a full screenshot of the display.

Example 6. The method of any of examples 1-5, wherein the validation response is based on a determination that the only text depicted by the screenshot is an expected set of text corresponding with the associated action.

Example 7. The method of example 6, wherein the validation response is based further on at least size or display coordinates of the expected set of text.

Example 8. The method of example 6, wherein the expected set of text comprises dynamic text.

Example 9. The method of any of examples 1-8, wherein capturing the screenshot is controlled by a secure-world subsystem of the computing device.

Example 10. The method of any of examples 1-9, wherein using the received validation response as a basis to control whether to allow the computing device to take the associated action in response to user input into the computing device when the UI is presented on the display is based on whether the validation response is affirmative.

Example 11. The method of any of examples 1-10, wherein using the received validation response as a basis to control whether to allow the computing device to take the associated action in response to user input into the computing device when the UI is presented on the display comprises using the received validation response to control whether or not to allow receipt of the user input when the UI is presented on the display.

Example 12. The method of any of examples 1-11, wherein the associated action comprises sharing of secure data.

Example 13. A computing device comprising: a display; a communication interface; a processing unit; non-transitory data storage; program instructions stored in the non-transitory data storage and executable by the processing unit to cause the computing device to carry out operations including: engaging in text-based validation of a user interface (UI) presented on the display, wherein engaging in the text-based validation of the UI includes (i) capturing a screenshot of the display when the UI is presented on the display, (ii) transmitting, through the communication interface, to a server a validation request providing the captured screenshot, and (iii) receiving from the server, in response to the validation request, a validation response based at least on (a) character recognition of text depicted by the screenshot and (b) a determination of whether the character-recognized text corresponds with an associated action, and using the received validation response as a basis to control whether to allow the computing device to take the associated action in response to user input into the computing device when the UI is presented on the display.

Example 14. The computing device of example 13, wherein user input into the computing device when the UI is presented on the display comprises at least one user input selected from the group consisting of (i) user biometrics data, (ii) user entry through a touch-screen interface of the display, and (iii) user input through button pressing on the computing device.

Example 15. The computing device of any of examples 13 and 14, wherein the validation response is based on a determination that the only text depicted by the screenshot is an expected set of text corresponding with the associated action.

Example 16. The computing device of any of examples 13-15, further comprising a trusted execution environment (TEE), wherein the TEE controls the capturing of the screenshot.

Example 17. A non-transitory computer-readable medium having stored thereon instructions executable by a processing unit to cause a computing device to carry out operations including: engaging in text-based validation of a user interface (UI) presented on a display of the computing device, wherein engaging in the text-based validation of the UI includes (i) capturing a screenshot of the display when the UI is presented on the display, (ii) transmitting to a server a validation request providing the captured screenshot, and (iii) receiving from the server, in response to the validation request, a validation response based at least on (a) character recognition of text depicted by the screenshot and (b) a determination of whether the character-recognized text corresponds with an associated action, and using the received validation response as a basis to control whether to allow the computing device to take the associated action in response to user input into the computing device when the UI is presented on the display.

Example 18. The non-transitory computer-readable medium of example 17, wherein user input into the computing device when the UI is presented on the display comprises at least one user input selected from the group consisting of (i) user biometrics data, (ii) user entry through a touch-screen interface of the display, and (iii) user input through button pressing on the computing device.

Example 19. The non-transitory computer-readable medium of any of examples 17 and 18, wherein the validation response is based on a determination that the only text depicted by the screenshot is an expected set of text corresponding with the associated action.

Example 20. The non-transitory computer-readable medium of any of examples 17-19, wherein the associated action comprises sharing of secure data.

Example 21. A computer-readable storage medium encoded with instructions that, when executed by one or more processors of a computing device, cause the one or more process to perform any combination of the methods of examples 1-12.

Example 22. A device comprising means for performing any combination of the methods of examples 1-12.

Examples have been described above. Those skilled in the art will understand, however, that changes and modifications may be made to these examples without departing from the true scope and spirit of the disclosure.

1. A method comprising:
engaging, by a computing device, in text-based validation of a user interface presented on a display of the computing device, wherein engaging in the text-based validation of the user interface includes:
(i) capturing a screenshot of the display when the user interface is presented on the display,
(ii) transmitting to a server a validation request providing the captured screenshot, and
(iii) receiving from the server, in response to the validation request, a validation response based at least in part on (a) character recognition of text depicted by the screenshot and (b) a determination of whether the character-recognized text corresponds with an associated action; and
using, by the computing device, the validation response as a basis to control whether to allow the computing device to take the associated action in response to user input into the computing device when the user interface is presented on the display.

2. The method of claim 1, wherein transmitting to the server the validation request providing the captured screenshot comprises encrypting the captured screenshot and transmitting the encrypted captured screenshot to the server.

3. The method of claim 1, wherein the user input into the computing device when the user interface is presented on the display comprises user biometrics data.

4. The method of claim 1, wherein the user input into the computing device when the user interface is presented on the display comprises at least one of (i) entry through a touch-screen interface of the display, (ii) pressing of a button on the computing device, or (iii) biometric input.

5. The method of claim 1, wherein the screenshot is a full screenshot of the display.

6. The method of claim 1, wherein the validation response is based on a determination that the only text depicted by the screenshot is an expected set of text corresponding with the associated action.

7. The method of claim 6, wherein the validation response is based further on at least size or display coordinates of the expected set of text.

8. The method of claim 6, wherein the expected set of text comprises dynamic text.

9. The method of claim 1, wherein capturing the screenshot is controlled by a secure-world subsystem of the computing device.

10. The method of claim 1, wherein using the received validation response as a basis to control whether to allow the computing device to take the associated action in response to user input into the computing device when the user interface is presented on the display is based on whether the validation response is affirmative.

11. The method of claim 1, wherein using the received validation response as a basis to control whether to allow the computing device to take the associated action in response to user input into the computing device when the user interface is presented on the display comprises using the received validation response to control whether or not to allow receipt of the user input when the user interface is presented on the display.

12. The method of claim 1, wherein the associated action comprises sharing of secure data.

13. A computing device comprising:
a display;
a communication interface;
a processing unit;
non-transitory data storage; and
program instructions stored in the non-transitory data storage and executable by the processing unit to cause the computing device to:
engage in text-based validation of a user interface presented on the display, wherein engaging in the text-based validation of the user interface includes (i) capturing a screenshot of the display when the user interface is presented on the display, (ii) transmitting, through the communication interface, to a server a validation request providing the captured screenshot, and (iii) receiving from the server, in response to the validation request, a validation response based at least on (a) character recognition of text depicted by the screenshot and (b) a determination of whether the character-recognized text corresponds with an associated action; and
use the received validation response as a basis to control whether to allow the computing device to take the associated action in response to user input into the computing device when the user interface is presented on the display.

14-15. (canceled)

16. The computing device of claim 13, wherein the program instructions that cause the computing device to transmit the validation request further cause the computing device to encrypt the captured screenshot and transmit the encrypted captured screenshot to the server.

17. The computing device of claim 13, wherein the user input into the includes user biometrics data.

18. The computing device of claim 13, wherein the user input includes at least one of (i) entry through a touch-screen interface of the display, (ii) pressing of a button on the computing device, or (iii) biometric input.

19. The computing device of claim 13, wherein the screenshot is a full screenshot of the display.

20. The computing device of claim 13, wherein the validation response is based on a determination that the only text depicted by the screenshot is an expected set of text corresponding with the associated action.

21. The computing device of claim 20, wherein the validation response is based further on at least size or display coordinates of the expected set of text, and wherein the expected set of text comprises dynamic text.

22. A non-transitory computer-readable storage medium encoded with instructions that, when executed by one or more processors of a computing device, cause the one or more processors to:
engage in text-based validation of a user interface presented on a display, wherein engaging in the text-based validation of the user interface includes (i) capturing a screenshot of the display when the user interface is presented on the display, (ii) transmitting, through a communication interface, to a server a validation request providing the captured screenshot, and (iii) receiving from the server, in response to the validation request, a validation response based at least on (a) character recognition of text depicted by the screenshot and (b) a determination of whether the character-recognized text corresponds with an associated action; and
use the received validation response as a basis to control whether to allow the computing device to take the associated action in response to user input into the computing device when the user interface is presented on the display.
